(19) United States
(12) Patent Application Publication
(10) Pub. No.: US 2009/0079527 A1
(43) Pub. Date: Mar. 26, 2009

(54) Yoke-integrated magnet

(75) Inventors: Takaaki Noda, Nissin-shi (JP); Fumiaki Hasegawa, Nakatsugawa (JP); Tatsuhiko Kurata, Nakatsugawa (JP); Kazuya Mizuno, Nakatsugawa (JP)

Correspondence Address: BACON & THOMAS, PLLC, 625 SLATERS LANE, FOURTH FLOOR, ALEXANDRIA, VA, 22314-1176, US

(73) Assignee: DAIDO ELECTRONICS CO., LTD., Nakatsugawa (JP)

(21) Appl. No.: 12/230,821

(22) Filed: Sep. 5, 2008

(30) Foreign Application Priority Data
Sep. 7, 2007 (JP) 2007-232640

(51) Int. Cl. H01F 7/02

(52) U.S. Cl. 335/303

(57) ABSTRACT

The present invention provides a yoke-integrated magnet, including: a ring-shaped bond magnet containing a rare earth iron-based alloy magnetic powder and a synthetic resin binder; and a ring-shaped back yoke provided on an inner periphery or an outer periphery of the bond magnet to be integral with the bond magnet, in which at least a surface of the bond magnet at which the bond magnet does not contact with the back yoke is covered with an injection molding layer of a thermoplastic resin which does not contain tin. The yoke-integrated magnet of the invention is excellent in corrosion resistance and dimension accuracy and is free from the risk of contamination with tin.

### FIELD OF THE INVENTION

The present invention relates to a yoke-integrated magnet and, particularly, to a yoke-integrated magnet containing a bond magnet, which is excellent in corrosion resistance and dimension accuracy and is free from contamination with tin.

### BACKGROUND OF THE INVENTION

Rare earth bond magnets have been noted for magnetic characteristics thereof that are remarkably superior to those of ferrite-based bond magnets, but a Nd—Fe—B-based or Sm—Fe—N-based raw material magnetic powder has a drawback that it tends to cause rusting due to pure iron contained therein. Therefore, such a rusting has heretofore been prevented by forming a coating film on a surface of a magnetic molded article by spray coating or electrophoretic coating. The electrophoretic coating has been usually employed since the electrophoretic coating is superior in uniformity of coating film and productivity as compared to the spray coating.

Japanese patent No. 3,644,080 discloses a method wherein an electrophoretic coating of a surface of a part for a motor is performed with an electrophoretic coating liquid suppressed in tin content in a solution to 12 ppm or less in order for preventing memory destruction of a recording medium being otherwise caused by tin contamination in the case of using the part for an HDD (hard disk drive) spindle motor or the like.

On the background of the recent demand for downsizing and high speed of HDD, the yoke-integrated magnet provided with a ring-shaped bond magnet, which is used for an HDD spindle motor or the like, is required to achieve further improvements in corrosion resistance and dimensional accuracy as well as to perfectly prevent the contamination with tin. However, with the electrophoretic coating that has widely been employed, it has been difficult to avoid a reduction in dimensional accuracy due to impression formed on the bond magnet surface when held with an electrophoretic tool and a reduction in circularity due to deformation of the bond magnet itself, and there has been a problem of generation of contamination with tin contained in the coating film.

### SUMMARY OF THE INVENTION

The invention has been achieved to solve the above-described problems, and an object thereof is to provide a yoke-integrated magnet that is excellent in corrosion resistance and dimensional accuracy and is free from contamination with tin.

In order to attain the above-described object, the invention provides the following (1) and (2).

(1) A yoke-integrated magnet, comprising:

a ring-shaped bond magnet comprising a rare earth iron-based alloy magnetic powder and a synthetic resin binder; and

a ring-shaped back yoke provided on an inner periphery or an outer periphery of the bond magnet to be integral with the bond magnet,

wherein at least a surface of the bond magnet at which the bond magnet does not contact with the back yoke is covered with an injection molding layer of a thermoplastic resin which does not contain tin.

(2) The yoke-integrated magnet according to claim (1) above,

wherein the injection molding layer covers only the surface of the bond magnet at which the bond magnet does not contact with the back yoke, and

wherein the yoke-integrated magnet has a resin pit formed at a boundary part between an end surface of the back yoke and an end surface of the bond magnet so that an end rim of the injection molding layer enters the resin pit to be bent in such a way that the injection molding layer holds the bond magnet along a peripheral surface of the bond magnet.

According to (1) above, excellent corrosion resistance is achieved since at least the surface of the bond magnet at which the bond magnet does not contact with the back yoke is covered with the injection molding layer containing no tin. Furthermore, excellent dimension accuracy is achieved since the magnet of the invention is free from a reduction in dimension accuracy due to the impression on the bond magnet surface as well as a reduction in circularity due to the deformation of the bond magnet itself, which are otherwise caused in the case of coating with the conventional electrophoretic coating film. Moreover, it is possible to perfectly prevent occurrence of contamination with tin.

According to (2) above, since occurrence of peeling and the like at the boundary part between an end surface of the injection molding layer and an end surface of the back yoke is reliably prevented by an anchoring effect of the end rim of the injection molding layer, the corrosion resistance is more reliably ensured.

As described in the foregoing, the yoke-integrated magnet of the invention is excellent in corrosion resistance and dimension accuracy and is free from contamination with tin.

### BRIEF DESCRIPTION OF THE DRAWINGS

FIG. 1 is a perspective view showing a whole part of a yoke-integrated magnet according to the first embodiment of the invention.

FIG. 2 is a cross sectional view taken along the line II-II of FIG. 1.

FIG. 3 is a flowchart showing a production process of the yoke-integrated magnet.

FIGS. 4A and 4B are sectional views showing a mold for producing the yoke-integrated magnet.

FIG. 5 is a sectional view showing an enlarge main part of another example of a mold for producing the yoke-integrated magnet.

FIG. 6 is a cross sectional view showing a yoke-integrated magnet according to the second embodiment of the invention.

### BEST MODE FOR CARRYING OUT THE INVENTION

The yoke-integrated magnet of the invention will now be described by way of preferred embodiments thereof with reference to the accompanying drawings.

### First Embodiment

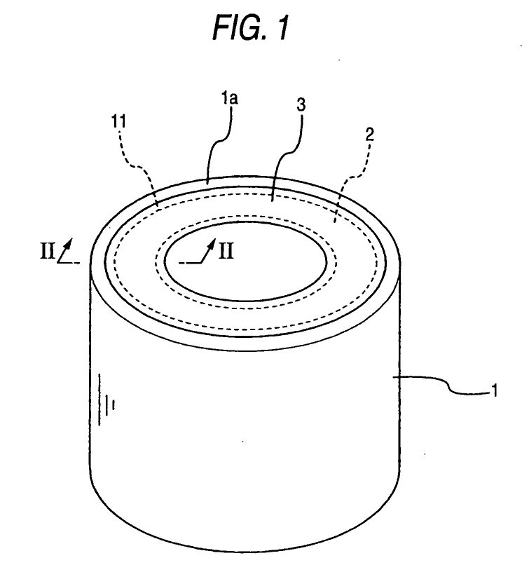

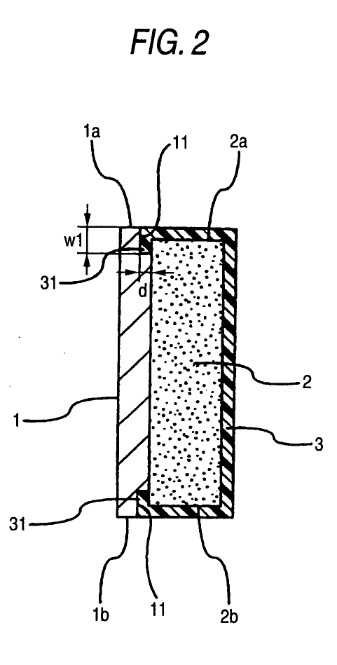

Shown in FIG. 1 is an appearance of a yoke-integrated magnet, and shown in FIG. 2 is a sectional view of the yoke-integrated magnet. As shown in each of the drawings, a ring-shaped bond magnet 2 is integrally provided on a back yoke 1 which contains a soft magnetic material and has a circular ring shape in such a way that the bond magnet 2 contacts with an inner periphery of the back yoke 1. As shown in FIG. 2, notches having a certain width w1 and a certain depth d are formed at the whole inner peripheries of openings at both ends of the back yoke 1 to serve as resin pit 11. The depth d is 20 to 500 μm and is substantially the same as a thickness of an injection molding layer 3 that will be described layer in this specification. The bond magnet 2 has a cylinder height that is lower than that of the back yoke 1, and end surfaces 2a and 2b of the bond magnet are recessed from end surfaces 1a and 1b of the back yoke 1 toward the inside of the cylinder by a length that is substantially the same as the depth d of the resin pit 11.

A surface of the bond magnet 2 is covered with the injection molding layer 3 having a thickness of 20 to 500 μm, which contains a thermoplastic resin and does not contain tin, except for the part contacting with the inner periphery of the back yoke 1.

The injection molding layer 3 covers from the whole inner periphery of the bond magnet 2 to the end surfaces 2a and 2b of the bond magnet 2 in such a way that a surface of the molding layer 3 is on an identical plane with the end surfaces 1a and 1b of the back yoke 1 and arrives at the resin pit 11 formed on the whole part of the inner peripheries at the both ends of the back yoke 1 to be bent in such a way that the injection molding layer 3 holds the bond magnet 2.

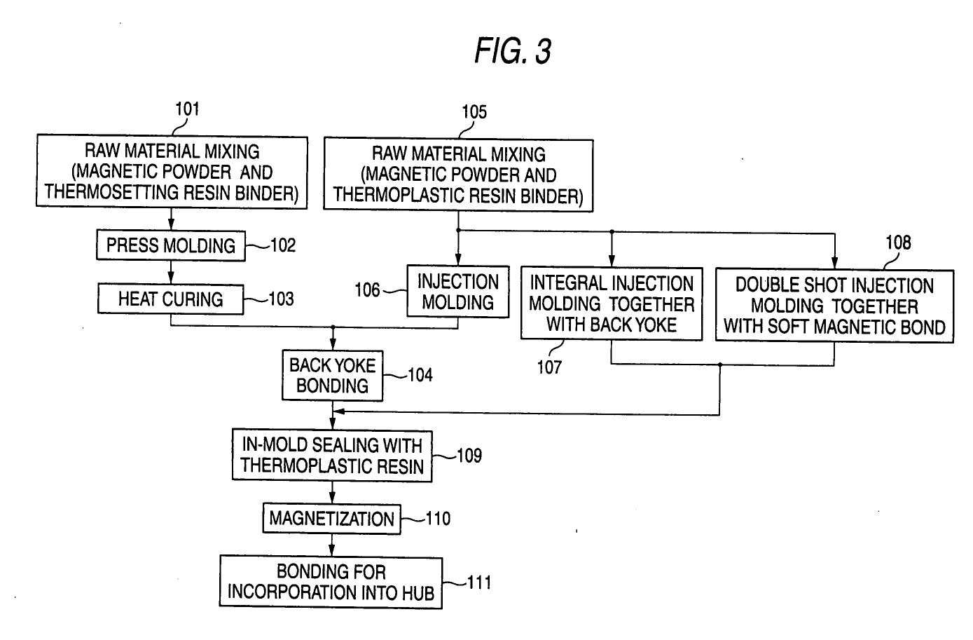

The yoke-integrated magnet may be produced by a production method shown in FIG. 3. In FIG. 3, a rare earth iron-based alloy magnetic powder and a thermosetting resin binder are mixed in Step 101. As the rare earth iron-based alloy magnetic powder, a Nd—Fe—B-based magnetic power or a Sm—Fe—N-based magnetic powder having an average diameter of 10 to 100 μm may be used alone or in combination. As the thermosetting resin binder, an epoxy resin, a phenol resin, or the like may be used. The mixture of the magnetic powder and the thermosetting resin binder is subjected to press-molding (Step 102), followed by thermosetting, thereby obtaining the bond magnet 2 (Step 103). The thus-obtained bond magnet 2 is fitted into the back yoke 1, followed by bonding and fixing them (Step 104).

As another production method, after mixing the magnetic powder with a thermoplastic resin binder such as Nylon 6 and polyphenylene sulfide (Step 105), the bond magnet 2 may be obtained by kneading-granulation and subsequent injection molding (Step 106). In place of the fitting of the bond magnet 2 into the back yoke 1, followed by bonding and fixing them, the back yoke 1 may be integrated with the bond magnet 2 by placing the back yoke 1 in a mold as an insertion material and then injecting the mixture of the magnetic power and the thermoplastic resin binder therein (Step 107). Alternatively, after performing double shot injection molding of the mixture of the magnetic powder and the thermoplastic resin binder together with a mixture of an iron powder as a soft magnetic material and the thermoplastic binder, the back yoke (soft material bond) 1 obtained from the latter mixture may be integrated with the bond magnet 2 obtained from the former mixture (Step 108).

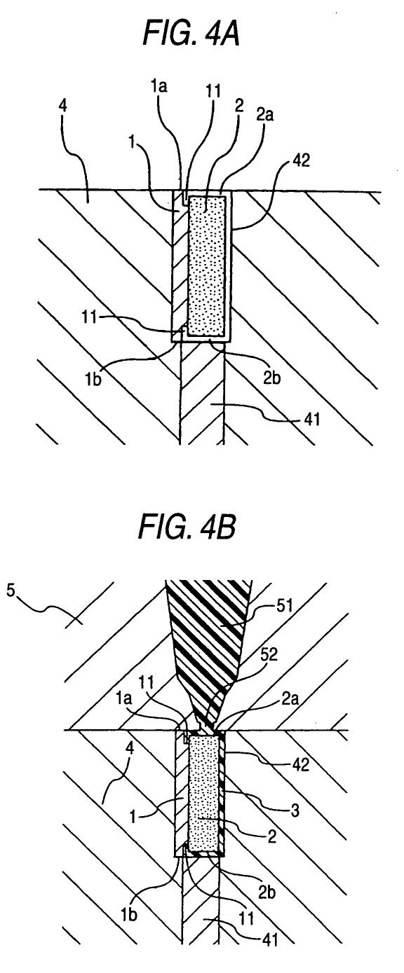

In Step 109 of FIG. 3, a surface of the bond magnet 2 provided integrally with the back yoke 1 is covered with the injection molding layer 3 having a predetermined thickness by injecting the tin-free thermoplastic resin as described above. The injection molding layer 3 is formed as described below. The bond magnet 2 integrally provided with the back yoke 1 is provided inside a cavity 42 of a movable mold (lower mold) 4 provided with a projecting pin 41 as shown in FIG. 4A. Subsequently, a fixed mold (upper mold) 5 is attached to the lower mold 4 as shown in FIG. 4B so that the thermoplastic resin is injected via a runner 51 and a gate 52 in this order into a space formed in the closed cavity 42. As the thermoplastic resin to be used in this case, Nylon 12, Nylon 6, polyphenylene sulfide (PPS), or the like may be used. In the case of using the back yoke-integrated magnet produced as described above for an HDD spindle motor, after the bond magnet 2 is magnetized (Step 110 of FIG. 3), the magnet is incorporated into a rotor hub, followed by bonding and fixing them (Step 111 of FIG. 3).

The yoke-integrated magnet produced by the above-described production method is excellent in corrosion resistance, because the whole part of the surface of the bond magnet 2 that does not contact with the inner periphery of the back yoke 1 is covered with the injection molding layer 3 that has the predetermined thickness (20 to 500 μm) and does not contain tin. Furthermore, the yoke-integrated magnet is excellent in dimension accuracy, because it is free from a reduction in dimension accuracy due to the impression on the bond magnet surface as well as a reduction in circularity due to the deformation of the bond magnet itself, which are otherwise caused in the case of coating with the conventional electrophoretic coating film. Moreover, it is possible to perfectly prevent the generation of contamination with tin. Particularly in this embodiment, since the resin pit 11 is formed on the whole inner peripheries of the openings at the both ends of the back yoke 1 and the injected resin is flown into the resin pit 11, the end rim 31 (see FIG. 2) of the injection molding layer 3 covering the inner periphery and the end surface of the bond magnet 2 is bent in such a way that the injection molding layer 3 holds the bond magnet 2 along the outer peripheral surface of the bond magnet 2. According to such a constitution, since occurrence of peeling and the like at the boundary part between an end surface of the injection molding layer 3 and an end surface of the back yoke 1 is reliably prevented by an anchoring effect of the end rim 31 of the injection molding layer 3, the corrosion resistance is more reliably ensured. The injection molding layer 3 may be formed on the whole periphery of the bond magnet 2.

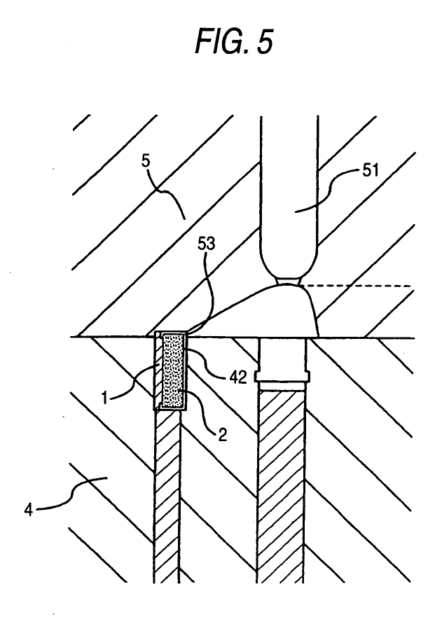

A film gate 53 shown in FIG. 5 may be used for forming the injection molding layer 3 from the thermoplastic resin. The film gate 53 is communicated with the runner 51 of the upper mold 5 and is opened from an inner side to the whole inner periphery upper end of the cavity space 42 at the contact surface of the upper mold 5 and the lower mold 4. With the use of the gate 53, since it is possible to form an injection trail along the inner periphery upper end of the injection molding layer 3, undulation on the end surface after the molding is reduced as compared to the case of forming the gate 52 on the end surface of the injection molding layer 3 as shown in FIG. 4, thereby making it possible to improve dimension accuracy in incorporation into a motor.

### Second Embodiment

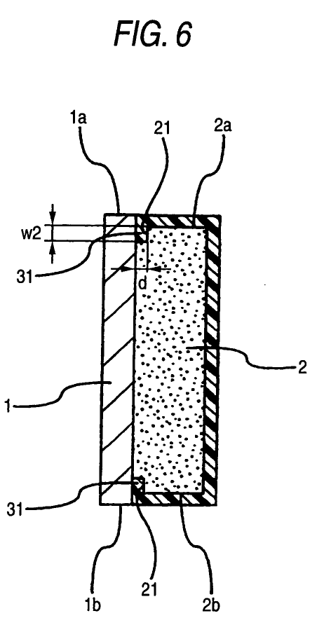

As shown in FIG. 6, it is also possible to achieve the effects same as those of the first embodiment when a notch having a certain width w2 and a certain depth d is formed on a whole outer periphery of the bond magnet 2 facing the openings at the both ends of the back yoke 1 to thereby form a resin pit 21 between the bond magnet 2 and the back yoke 1.

The invention is not limited to the structure in which the back yoke 1 is positioned on the outer periphery side of the bond magnet 2, and it is also applicable to a yoke-integrated magnet having a structure in which the back yoke 1 is positioned on an inner periphery side of the bond magnet 2.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2007-232640 filed on Sep. 7, 2007, the contents thereof being incorporated herein by reference.

What is claimed is:

1. A yoke-integrated magnet, comprising:
a ring-shaped bond magnet comprising a rare earth iron-based alloy magnetic powder and a synthetic resin binder; and
a ring-shaped back yoke provided on an inner periphery or an outer periphery of the bond magnet to be integral with the bond magnet,
wherein at least a surface of the bond magnet at which the bond magnet does not contact with the back yoke is covered with an injection molding layer of a thermoplastic resin which does not contain tin.

2. The yoke-integrated magnet according to claim 1,
wherein the injection molding layer covers only the surface of the bond magnet at which the bond magnet does not contact with the back yoke, and
wherein the yoke-integrated magnet has a resin pit formed at a boundary part between an end surface of the back yoke and an end surface of the bond magnet so that an end rim of the injection molding layer enters the resin pit to be bent in such a way that the injection molding layer holds the bond magnet along a peripheral surface of the bond magnet.
